(19) United States
(12) Patent Application Publication
(10) Pub. No.: US 2003/0191639 A1
(43) Pub. Date: Oct. 9, 2003

(54) Dynamic and adaptive selection of vocabulary and acoustic models based on a call context for speech recognition

(76) Inventor: Sam Mazza, Fort Lee, NJ (US)

Correspondence Address: PILLSBURY WINTHROP, LLP, P.O. BOX 10500, MCLEAN, VA, 22102, US

(21) Appl. No.: 10/115,936

(22) Filed: Apr. 5, 2002

(51) Int. Cl. G10L 15/00

(52) U.S. Cl. 704/231

(57) ABSTRACT

An arrangement is provided for dynamic and adaptive selection of vocabulary and acoustic models based on a call context for speech recognition. When a call is received from a caller who is associated with a customer, relevant call information associated with the call is forwarded and used to detect a call context. At least one vocabulary is selected based on the call context. Acoustic models with respect to each selected vocabulary are identified based on the call context. The vocabulary and the acoustic models are then used to recognize the speech content of the call from the caller. Reservation of Copyright

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to automated-speech processing. Other aspects of the present invention relate to adaptive automatic speech recognition.

In a society that is becoming increasingly service oriented, choices of products are often determined according to accompanying customer services offered with the products. Companies invest much capital in providing such services in order to attract customers. For example, a customer who purchases a computer from a manufacturer may be provided with a toll free telephone number so that the customer can call for any technical support or service questions. To facilitate offered customer services, a manufacturer may establish a call center equipped with call routing capabilities (e.g., route a call to an available agent), backend database systems managing relevant information such as customer profiles, and personal who are capable of handling different types of questions. There may be other possible system configurations besides call centers that are deployed to facilitate customer services.

Maintaining a call center is costly. To effectively compete in the market place, the cost associated with customer services has to be kept low. Various strategies of saving cost have been developed. One such strategy is to introduce automatic call routing capability so that there is no need to hire operators whose job is merely direct calls to appropriate agents. Such automatic call routing facilities automatically interpret the needs related to a calling customer (e.g., a customer may have a billing question) and then automatically route the customer's call to an agent who is specialized in the particular domain (e.g., an agent who is responsible for handling billing related questions).

There are mainly two categories of techniques to realize automatic call routing. One is to prompt a calling customer to enter coded choices. For example, a call center may prompt a customer to “enter 1 for placing an order; enter 2 for billing questions; enter 3 for promotions.”. With this implementation, a customer may enter the code corresponding to desired service using a device with keys such as a telephone. Since this type of solution requires a calling customer's effort, it may annoy some customers, especially when the number of choices is large enough so that a customer may have trouble to remember the code for each service choice after hearing the prompt.

Another category of techniques is to automate call routing via voice. In this case, a call center may prompt a calling customer to say what category of service is being requested. Since a customer, in this case, does not have to remember the code for each choice, it is often more convenient. To realize this type of solutions, a call center usually deploys an automatic speech recognition system that recognizes the spoken words from the speech of a calling customer. The recognized spoken words are then used to route the call. Due to the fact that a call center usually handles calls potentially from many different customers, it usually deploys an automatic speech recognition system that is speaker independent (as opposed to speaker dependent system). Independent speaker voice recognition, although more flexible than speaker dependent voice recognition, is less accurate.

To minimize the recognition inaccuracy of using a speaker independent system, a smaller than normal vocabulary may be used. With this technique, if a call center prompts a calling customer at a particular stage of the call to state one of the three given service choices, to recognize what the customer will say, a vocabulary of only three words may be selected for recognition. For example, if a customer is given choices of “information”, “operator”, and “billing”, to recognize what the customer will choose, a vocabulary consisting of only these three words is selected (as opposed to a generic vocabulary containing thousands of words) for recognition purposes. Using a smaller vocabulary helps to narrow the scope of the recognition and, hence, improve recognition accuracy. With this technique, at different stages of a call, different vocabularies are selected based on the requirements of an underlying application.

In many real systems, even with flexible selection of vocabularies at different stages of a call, recognition accuracy is often not good enough. This is especially true when the underlying vocabulary is not small enough. It is a difficult task to perform automated speech recognition that is speaker independent. Even with a relatively small vocabulary, different customers may state a same choice with very different speech features. For example, word “operator” may be pronounced quite differently by an American native speaker and a Japanese national.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 depicts a framework in which a caller's speech is recognized using vocabulary and acoustic models adaptively selected based on a call context, according to embodiments of the present invention;

FIG. 2 depicts the internal high level functional block diagram of a speech recognition mechanism that is capable of adapting its vocabulary and acoustic models to a call context, according to embodiments of the present invention;

FIG. 3 illustrates exemplary relevant information of a call context that may affect the adaptive selection of a vocabulary and associated acoustic models, according to embodiments of the present invention;

FIG. 4 describes an exemplary relationship between vocabularies and acoustic models, according to an embodiment of the present invention;

FIG. 5 is an exemplary flowchart of a process, in which a caller's speech is recognized using vocabulary and acoustic models adaptively selected based on a call context, according to an embodiment of the present invention;

FIG. 6 is an exemplary flowchart of a process, in which a vocabulary adaptation mechanism dynamically selects an appropriate vocabulary according to a call context, according to an embodiment of the present invention;

FIG. 7 is an exemplary flowchart of a process, in which an acoustic model adaptation mechanism dynamically selects an appropriate acoustic models with respect to a vocabulary based on a call context, according to an embodiment of the present invention; and

FIG. 8 is an exemplary flowchart of a process, in which acoustic models used for speech recognition are adaptively adjusted based on speech recognition performances, according to an embodiment of the present invention.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

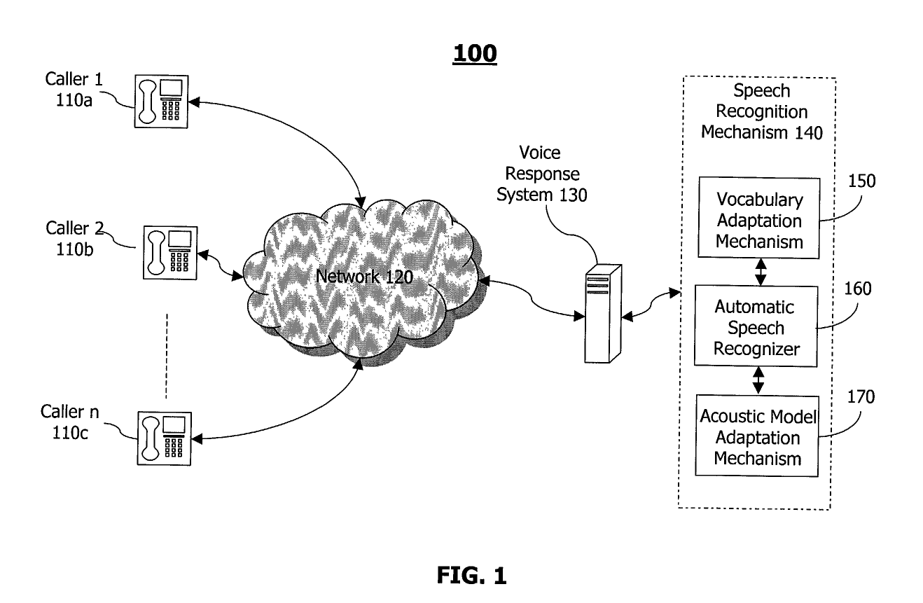

FIG. 1 depicts a framework 100 in which a caller's speech is recognized using vocabulary and acoustic models adaptively chosen based on a call context, according to embodiments of the present invention. Framework 100 comprises a plurality of callers (caller 1 110a, caller 2 110b, . . . , caller n 110c), a voice response system 130, and a speech recognition mechanism 140. A caller communicates with the voice response system 130 via a network 120. Upon receiving a call from a caller via the network 120, the voice response system 140 identifies and forwards information relevant to the call to the speech recognition mechanism 140. Based on such information, the speech recognition mechanism 140 adaptively selects one or more vocabularies and acoustic models, appropriate with respect to the call information and the caller, that are then used to recognize spoken words uttered by the caller during the call.

A caller may place a call via either a wired or a wireless device, which can be a telephone, a cellular phone, or any communication device, such as a personal data assistant (PDA) or a personal computer, that is capable of transmitting either speech (voice) data or features transformed from speech data. The network 120 represents a generic network, which may correspond to, but not limited to, a local area network (LAN), a wide area network (WAN), the Internet, a wireless network, or a proprietary network. The network 120 is capable of not only transmitting data but also relaying useful information related to the transmission, together with the transmitted data, to the voice response system 130. For example, the network 120 may include switches, routers, and PBXes that are capable of extracting information related to the caller and attaching such information with the transmitted data.

The voice response system 130 represents a generic voice enabled system that responds to the speech from a caller by taking appropriate actions based on what a caller says during a call. For example, the voice response system 130 may correspond to an interactive voice response (IVR) system deployed at a call center. When a caller places a call to the call center, the IVR system may automatically direct the call to an appropriate agent at the call center based on what is said by the caller. For instance, if a caller calls for a billing question, the IVR system should direct the call to an agent who is trained to answer billing questions. If the caller asks for directory assistance, the IVR system should direct the call to an agent who is on duty to help callers to find desired phone numbers.

To appropriately act based on a caller's voice request, the voice response system 130 relies on the speech recognition mechanism 140 to recognize what is being said in the caller's speech. To improve recognition accuracy, the voice response system 130 may actively prompt a caller to answer certain questions. For example, upon intercepting a call, the voice response system 130 may ask the caller to state one of several given types of assistance that he/she is seeking (e.g., “place an order”, “directory assistance”, and “billing”).

The answer from the caller may be not only utilized to guide the voice response system 130 to react but also useful in terms of selecting an appropriate vocabulary for speech recognition purposes. For instance, knowing that a caller's request is for billing service, the voice response system 130 may further prompt the caller to provide an account number. Given this context, the speech recognition mechanism 140 may utilize a digits vocabulary (a vocabulary consisting of only digits, if an account number is known to consist of only digits) to recognize what will be said in the caller's response. The choice of a particular vocabulary may depend on an underlying application. For example, if an account is known to be composed of a combination of digits and letters, the speech recognition mechanism 140 may utilize both a digit vocabulary and a letter vocabulary (consisting of only letters) to form a combined vocabulary. A choice of a vocabulary may also be language dependent. For instance, if a caller speaks only Spanish, a Spanish vocabulary has to be used.

Using a particular vocabulary in speech recognition may narrow down the scope of what needs to be recognized, which improves both the efficiency and accuracy of the speech recognition mechanism 140. Another dimension affecting the performance of a speech recognizer involves whether a caller's speech characteristics are known. For example, a French person may speak English with a French accent. In this case, even with an appropriately selected vocabulary, recognition accuracy on, for example, recognizing English digits spoken by a French person using an English digit vocabulary may result in poor recognition accuracy. In speech recognition, acoustic models capture the acoustic realization of phonemes in context corresponding to spoken words. A vocabulary realized in different languages may correspond to vastly different acoustic models. Similarly, a vocabulary in a particular language yet realized with different accents (e.g., speak digits in English with a French accent) may also yield distinct acoustic models.

The speech recognition mechanism 140 adaptively selects both vocabulary and associated acoustic models appropriate for recognition purposes. It comprises a vocabulary adaptation mechanism 150, an acoustic model adaptation mechanism 170, and an automatic speech recognizer 160. The vocabulary adaptation mechanism 150 determines appropriate vocabularies based on information related to a particular call as well as the underlying application. For example, it may select an English digit vocabulary based on the fact that the caller is known to be an English speaker (e.g., based on either prior knowledge about the customer or automated recognition results) and the caller requests service related to billing questions. In this case, the English digit vocabulary is chosen for upcoming recognition of what will be said by the caller in answering the question, for instance, about his/her account number. Therefore, an appropriate vocabulary may selected based on both application needs (e.g., to answer a billing question, an account number is required) and the information about a particular caller (e.g., English speaking with a French accent).

The acoustic model adaptation mechanism 170 adaptively selects acoustic models based on a selected vocabulary (by the vocabulary adaptation mechanism 150) and the information related to the underlying call. For example, assume an incoming call is for a billing related question and the caller is known (e.g., the customer profile associated with the caller ID may reveal so) to be an English speaker with a French accent. In this case, the vocabulary adaptation mechanism 150 selects an English digit vocabulary. Based on the vocabulary selection and the known context of the call (e.g., information about the caller), the acoustic model adaptation mechanism 170 may select the acoustic models that characterize speech properties of spoken English digits with French accent.

If a caller's speech characteristics are not known a priori (e.g., accent), the acoustic model adaptation mechanism 170 may determine, on-the-fly, the best acoustic models suitable for a particular caller. For example, the acoustic model adaptation mechanism 170 may dynamically, during the course of speech recognition, adapts to appropriate acoustic models based on the recognition performance of the automatic speech recognizer 160. It may continuously monitor the speech recognition performance and accordingly adjust the acoustic models to be used. The updated information is then stored and associated with the call-information for future use.

When a vocabulary and corresponding acoustic models are both appropriately chosen, the automatic speech recognizer 160 performs speech recognition on incoming speech (from the caller) using the selected vocabulary and acoustic models. The recognition result is then sent to the voice response system 130 so that it can properly react to the caller's voice request. For example, if a caller's account number is recognized, the voice response system 130 may pull up the account information and prompt the caller to indicate what type of billing information the caller is requesting.

The reaction of the voice response system 130 may further trigger the speech recognition mechanism 140 to adapt to select different vocabulary and acoustic models for upcoming recognition. For example, to facilitate the automatic speech recognizer 160 to recognize the upcoming answer about the type of billing question (from the caller), the vocabulary adaptation mechanism 150 may select a vocabulary consisting of three words corresponding to three types of billing questions (e.g., “balance”, “credit”, and “last payment”). The acoustic model adaptation mechanism 170 may then accordingly select the acoustic models of the three-word vocabulary that correspond to, for example, French accent. Therefore, both the vocabulary adaptation mechanism 150 and the acoustic adaptation mechanism 170 adapt to the changing context of a call and dynamically select the vocabularies and acoustic models that are most appropriate given the call context.

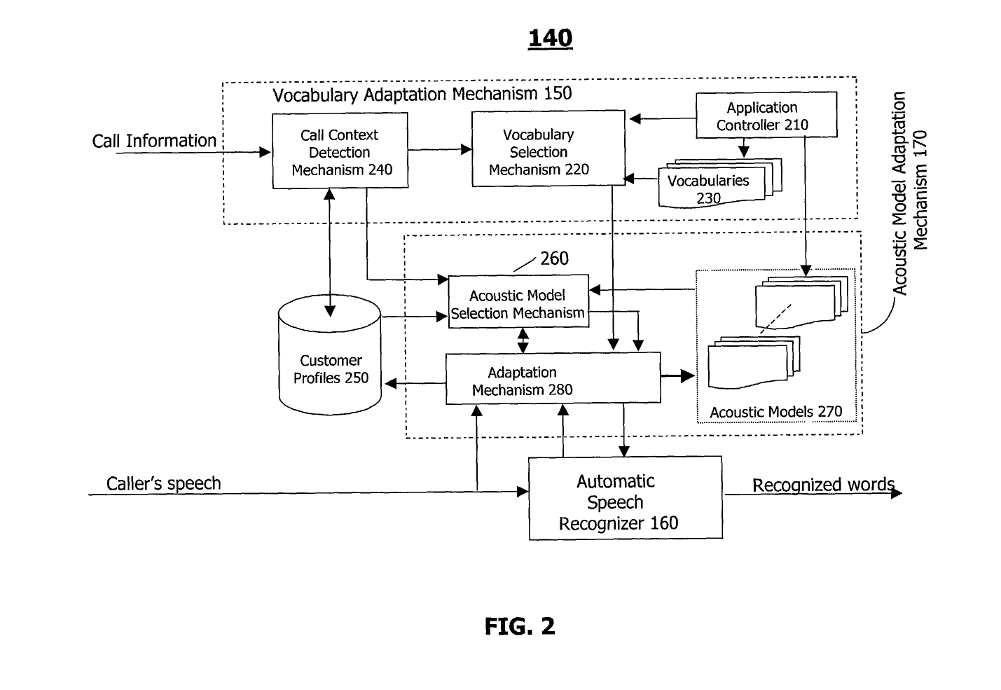

FIG. 2 depicts the internal high level functional block diagram of the speech recognition mechanism 140, according to embodiments of the present invention. The vocabulary adaptation mechanism 150 comprises an application controller 210, a call context detection mechanism 240, a vocabulary selection mechanism 220, and a plurality of available vocabularies 230. The vocabulary selection mechanism 220 chooses appropriate vocabularies based on a call context, detected by the call context detection mechanism 240, and the application requirement, determined by the application controller 210.

The application controller 210 may dictate the choice of type of vocabulary from the standpoint of what an application requires. For example, if an account number in a particular application consists of only digits (determined by the application controller 210), a digit vocabulary is needed to recognize a spoken account number. If an account number in a different application consists of digits and letters, both a digit vocabulary and a letter vocabulary are required to recognize a spoken account number.

A call context associated with a call (may also associate with different time instances during the call) may dictate the choice of a vocabulary from the standpoint of linguistic requirement. For example, if a digit vocabulary is required by an application, there are choices in terms of which digit vocabulary of a particular language is required. This may be determined according to the call context. For example, if the caller is a French speaking person, a French digit vocabulary is needed.

The call context detection mechanism 240 receives information either forwarded from the voice response system 130 or retrieved from a customer profile associated with the caller or from the network. For example, the voice response system 130 may forward call related information such as a caller identification number (caller ID) or an area code representing an area from where the call is initiated. A caller ID may be used to retrieve a corresponding customer profile that may provide further information such as the language preference of the caller. Using such information, the call context detection mechanism 240 constructs the underlying call context, which may be relevant to the selection of appropriate vocabularies or acoustic models.

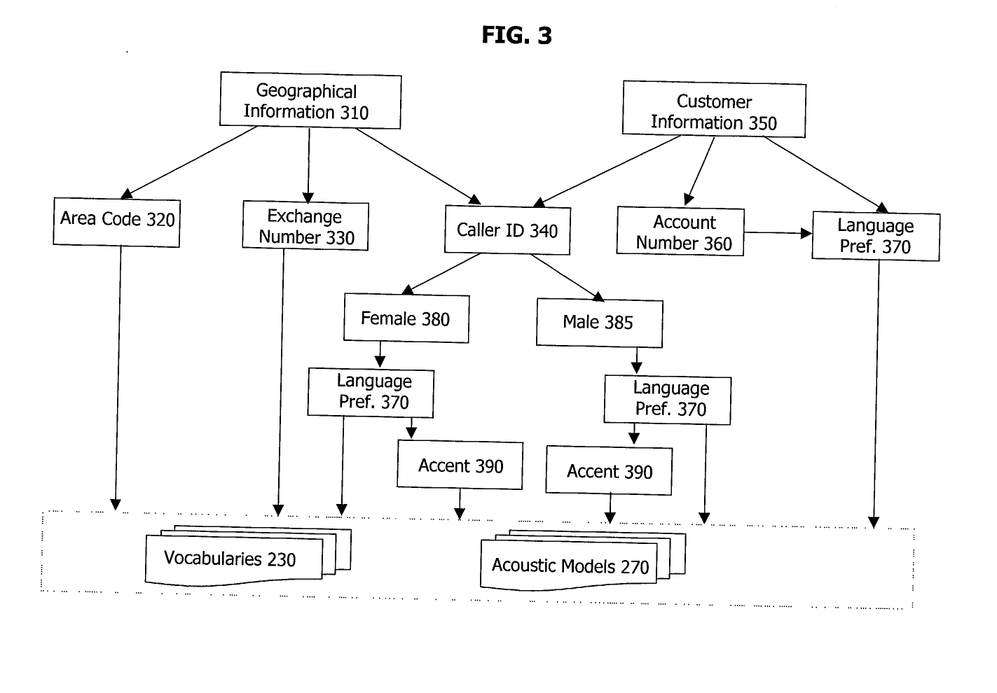

FIG. 3 illustrates exemplary relevant types of information within a call context that may affect the selection of a vocabulary and associated acoustic models, according to embodiments of the present invention. The information forwarded from the voice response system 130 may correspond to geographical information 310, including, for example, an area code 320, an exchange number 330, or a caller ID 340. Such information may be associated with a physical location where the call is initiated, which may be identified from the area code 320, the exchange number 330, or, probably most precisely, from the caller ID 340. Geographical information may be initially gathered at a local carrier when the call is initiated and then routed (with the call) via the network 120 to the voice response system 130.

The customer information retrieved from a customer profile may include, for example, one or more corresponding caller IDs 340, an account number 360, . . . , and language preference 370. Using a received caller ID (from the voice response mechanism 130), information contained in the associated customer profile may be retrieved. For example, given a caller ID, the language preference 370 may be retrieved from an associated customer profile. The language preference 370 may be indicated via different means. For instance, it may be entered when the underlying account is set up or it may be established during the course of dealing with the customer.

Different callers may use a same caller ID. A customer profile may record each of such individual potential callers and their language preferences (not shown in FIG. 3). Alternatively, a customer profile may distinguish female callers 380 from male callers 390 (e.g., in a household) and their corresponding language preferences due to the fact that female and male speakers usually present substantially different speech characteristics so that distinct acoustic models may be used to recognize their speech.

Geographical information related to a call can be used to obtain more information relevant to the selection of vocabularies and acoustic models. For example, a caller ID forwarded from the voice response system 130 can be used to retrieve a corresponding customer profile that provides further relevant information such as language preference. Using the retrieved language preference 370 (combined with a required type of vocabulary according to application needs), an appropriate vocabulary (e.g., English digit vocabulary) and acoustic models (e.g., acoustic models for English digits in French accent) may be determined.

When a caller ID is not available, direct access to a customer profile may not be possible. Consequently, a preferred language may not be known. In this case, the area code 320 or the exchange number 330 may be used to infer a language preference. For instance, if the area code 320 corresponds to a geographical area in Texas, it may be inferred that acoustic models corresponding to a Texan accent may be appropriate. As another example, if the exchange number 330 corresponds to a region (e.g., Chinatown in New York City), in which majority people speak English with a particular accent (i.e., Chinese living in Chinatown of New York City speak English with Chinese accent), a particular set of acoustic models corresponding to the inferred accent may be considered as appropriate.

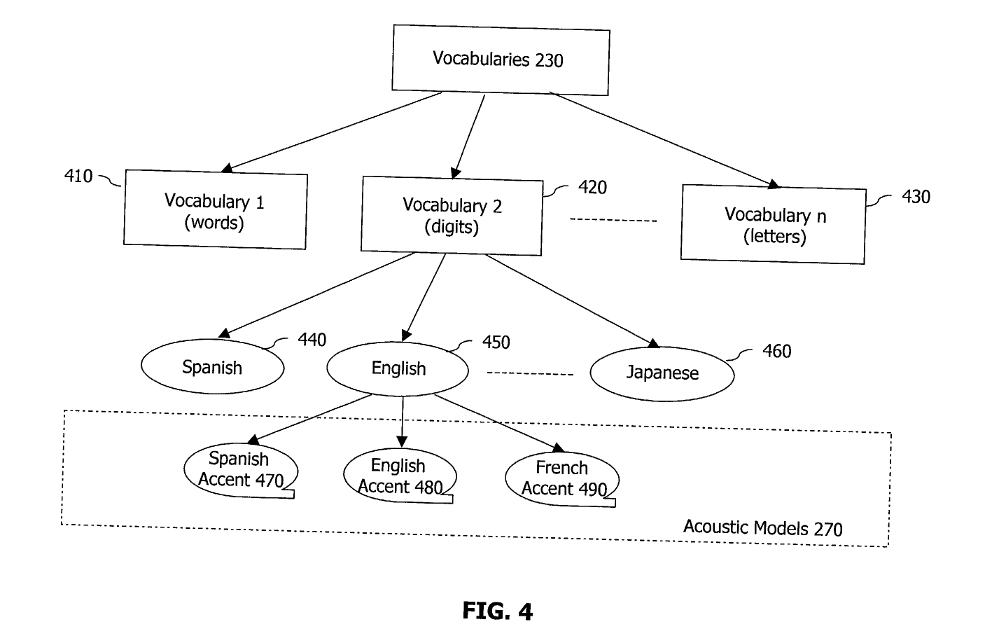

As discussed earlier, selection of acoustic models depends on not only the speech characteristics of a caller but also the choice of vocabularies. FIG. 4 illustrates an exemplary relationship between vocabularies and acoustic models, according to an embodiment of the present invention. The vocabularies 230 includes a plurality of vocabularies (vocabulary 1 410, vocabulary 2 420, . . . , vocabulary n 430). Each vocabulary may have realizations in different languages. For example, digit vocabulary 420 may include Spanish digit vocabulary 440, English digit vocabulary 450, . . . , and Japanese digit vocabulary 460. In addition, with respect to each vocabulary in a given language, a plurality of acoustic models corresponding to different accents may be available. For instance, for the English digit vocabulary 450, acoustic models corresponding to Spanish accent (470), English accent 480, and French accent 490 may be selected consistent with the speech characteristics of a caller.

To select appropriate acoustic models, the acoustic model adaptation mechanism 170 may make the selection based on either the given information, such as the selection of a vocabulary (made by the vocabulary adaptation mechanism 150) and the information contained in a call context, or information gathered on-the-fly, such as the speech characteristics detected from a caller's speech. Referring to FIG. 2, the acoustic model adaptation mechanism 170 comprises an acoustic model selection mechanism 260, an adaptation mechanism 280, and a collection of available acoustic models 270. The acoustic selection mechanism 260 receives a call context from the call context detection mechanism 240. Information contained in the call context may be used to determine a selection of appropriate acoustic models (see FIG. 3).

When the received call context does not provide needed information to make a selection, the adaptation mechanism 280 may detect, during the call, speech characteristics from the caller's speech (e.g., whether the caller is a female or a male speaker) that may be relevant to the selection. The detected speech characteristics may also be used to identify information in the associated customer profile that are useful to the selection. For example, if a female voice is detected, the acoustic model selection mechanism 260 may use that information to see whether there is a language preference associated with a female speaker in the customer profile (accessed using, for example, a caller ID in the call context). In this case, the selection is dynamically determined, on-the-fly, according to the speech characteristics of the caller.

A different exemplary alternative to achieve adaptation on-the-fly when there is no information available to assist the selection of acoustic models is to initially select a set of acoustic models according to some criteria and then refine the selection based on the on-line performance of speech recognition. For example, given an English digit vocabulary, the acoustic model selection mechanism 260 may initially choose acoustic models corresponding to English accent, Spanish accent, and French accent. All such initially selected acoustic models are then fed to the automatic speech recognizer 160 for speech recognition (e.g., parallel speech recognition against different accents). The performance measures (e.g., scores of the recognition) are produced during the recognition and sent to the adaptation mechanism 280 to evaluate the appropriateness of the initially selected acoustic models. The acoustic models resulting in poorer recognition performance may not be considered for further recognition in the context of this call. Such on-line adaptation may continue until the most appropriate acoustic models are identified.

The final on-line adaptation results (choices of acoustic models adjusted to achieve optimal speech recognition performance) may be used to update the underlying customer profile. For example, an underlying customer profile that originally has no indication of any language preference and accent may be updated with the on-line adaptation results, together with associated speech characteristics. For instance, a female speaker (speech characteristics) of a household (corresponding to a caller ID) has a French accent. Such updated information in the customer profile may be used in the future as a default selection with respect to a particular kind of speaker.

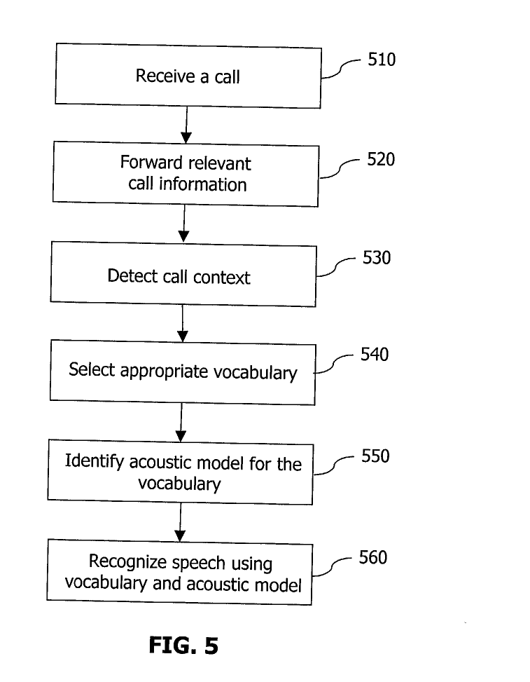

FIG. 5 is an exemplary flowchart of a process, in which a caller's speech is recognized using vocabulary and acoustic models that are adaptively selected based on a call context, according to an embodiment of the present invention. A call is first received at act 510. Information relevant to the call is then forwarded, at act 520, from the voice response system 130 to the speech recognition mechanism 140. A call context is detected at act 530 and is used to select, at act 540, an appropriate vocabulary. Based on the selected vocabulary and the detected call context, proper acoustic models are identified at act 550. Using such selected vocabulary and the acoustic models, the automatic speech recognizer 160 performs speech recognition, at act 560, on the caller's speech.

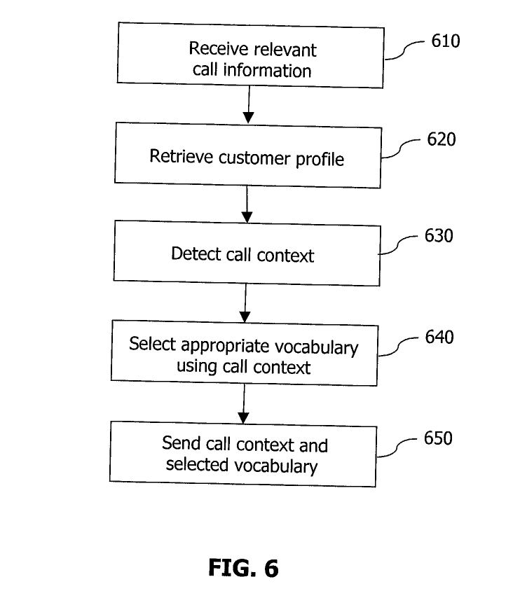

FIG. 6 is an exemplary flowchart of a process, in which the vocabulary adaptation mechanism 160 dynamically selects an appropriate vocabulary according to a call context, according to an embodiment of the present invention. Information relevant to a call is received at act 610. Based on the call information, a customer profile may be retrieved at act 620. From the call information and the customer profile, a call context is detected, at act 630, and an appropriate vocabulary is selected accordingly at act 640. The selected vocabulary, together with the call context, is then sent, at act 640, to the acoustic model adaptation mechanism 170.

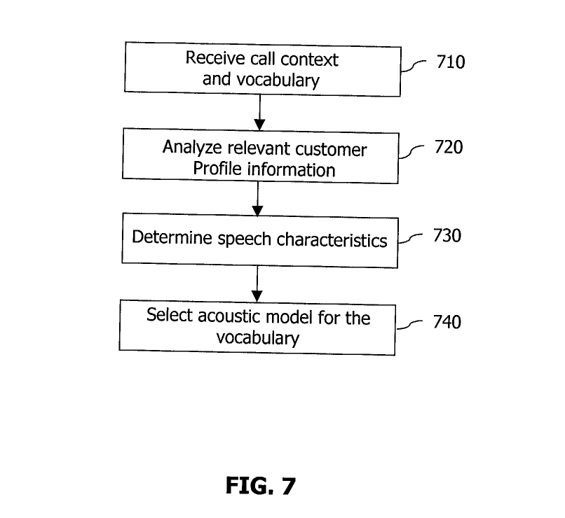

FIG. 7 is an exemplary flowchart of a process, in which the acoustic model adaptation mechanism 170 dynamically selects appropriate acoustic models with respect to a vocabulary based on a call context, according to an embodiment of the present invention. A call context and a selected vocabulary is first received at act 710. Using the call context, relevant customer information is analyzed at act 720. When necessary, speech characteristics of the caller are determined at act 730. Acoustic models that are appropriate with respect to the given vocabulary and the call context (including the speech characteristics detected on-the-fly) are selected at act 740.

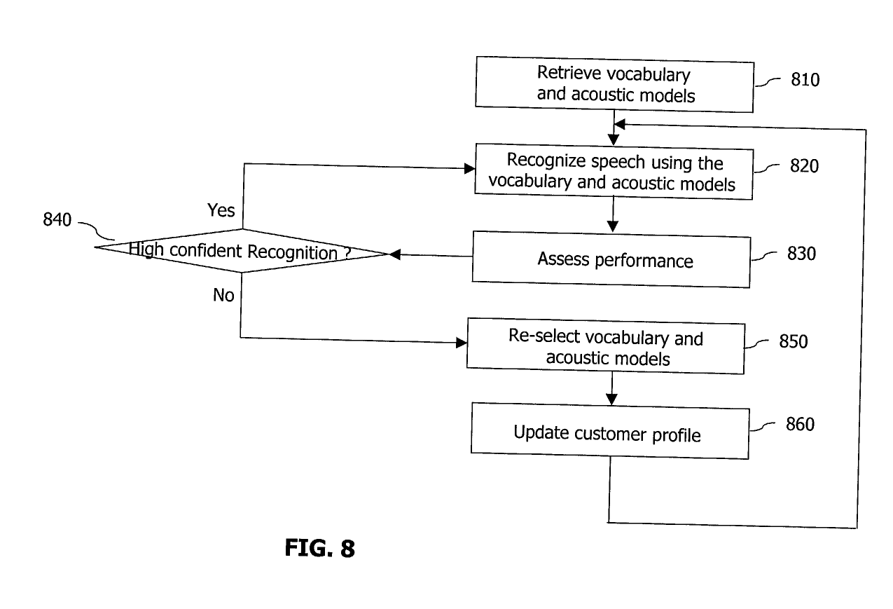

FIG. 8 is an exemplary flowchart of a process, in which vocabularies and acoustic models used for speech recognition are adaptively adjusted on-the-fly based on speech recognition performances, according to an embodiment of the present invention. Adaptively selected vocabulary and acoustic models are first retrieved, at act 810, and then used to recognize, at act 820, the speech from a caller. Performance measures are generated during the course of recognition and are used to assess, at act 830, the recognition performance. If the assessment indicates that a high confidence is achieved during the recognition, determined at act 840, current vocabulary and acoustic models are continuously used for on-going speech. Otherwise, vocabulary and acoustic models that may lead to improved recognition performance are re-selected at act 850. Information related to the re-selection (e.g., the newly selected vocabulary and acoustic models) is used to update the underlying customer profile. This model adaptation process may continue until the end of the call.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments and extends to all equivalent structures, acts, and, materials, such as are within the scope of the appended claims.

What is claimed is:

1. A method, comprising:
receiving a call from a caller associated with a customer;
fowarding relevant call information associated with the call;
detecting a call context associated with the call based on the call information;
selecting at least one vocabulary according to the call context;
identifying at least one acoustic model for each of the at least one vocabulary based on the call context; and
recognizing speech content of the call using the at least one vocabulary and the at least one acoustic model.

2. The method according to claim 1, wherein
the at least one vocabulary includes at least some of:
a digits vocabulary in a particular language,
a letter vocabulary in a particular language,
a word vocabulary in a particular language, and
a generic vocabulary in a particular language; and
the at least one acoustic model representing a specific accent with respect to a particular vocabulary.

3. The method according to claim 2, wherein the call context includes at least some of:
geographical information associated with the call which includes:
an area code representing a geographical area from where the call is placed,
an exchange number representing a geographical region from where the call is placed, or
a caller identification number representing a phone through which the call is placed by the caller;
customer information associated with the customer which includes:
an account number representing an account using which the customer places the call,
the caller identification number associated with the account;
customer characteristics; or
an on-the-fly voice sample used to evaluate voice characteristics.

4. The method acording to claim 3, wherein the customer characteristics associated with the customer include at least some:
gender of at least one caller associated with the customer;
zero or more languages for communication preferred by the at least one caller; or
speech accent with respect to the preferred languages of the at least one caller.

5. The method according to claim 4, wherein said detecting a call context comprises at least some of:
extracting the geographical information of the call from the relevant call information associated with the call;
identifying the customer information from a customer profile corresponding to the account number using which the customer places the call; or
identifying the customer characteristics based on the speech of the customer.

6. The method according to claim 1, further comprising:
accessing the performance of said recognizing;
re-selecting at least some of the vocabulary and the acoustic models that correspond to better performance of said recognizing according to said assessing.

7. A method for selecting an appropriate vocabulary, comprising:
receiving call information relevant to a call placed by a caller associated with a customer;
retrieving, if the call information provides appropriate identification, a customer profile, accessed using the appropriate identification, to obtain customer information;
detecting a call context associated with the call based on the call information and the customer information; and
selecting an appropriate vocabulary based on the call context.

8. The method according to claim 7, wherein said detecting comprises:
extracting geographical or customer information from the call information;
obtaining customer information from the customer profile; or
detecting caller characteristics based on the speech of the caller.

9. A method for selecting an appropriate acoustic model, comprising:
receiving a call context, relevant to a call placed by a caller associated with a customer, and a vocabulary; and
selecting at least one acoustic model with respect to the vocabulary based on the a call context.

10. The method according to claim 9, wherein said selecting includes at least some of:
analyzing relevant customer information contained in the a call context; and
determining the speech characteristics of the caller from the speech of the caller.

11. A method for adaptively adjusting vocabulary and acoustic model selection, comprising:
performing speech recognition using at least one vocabulary and associated at least one acoustic model, selected according to a call context related to a call from a caller, on the speech from the caller;
assessing the performance of the speech recognition with respect to each of the at least one vocabulary and each of its associated acoustic models; and
re-selecting an updated vocabulary or an updated acoustic model based on assessed speech recognition performance so that said performing speech recognition is to be carried out using the updated vocabulary and the updated acoustic model.

12. The method system according to claim 11, further comprising:
updating a customer profile, associated with the caller, based on the updated acoustic model.

13. A system, comprising:
a caller for making a call; and
a speech recognition mechanism for recognizing the speech of the caller using at least one vocabulary and at least one acoustic model selected adaptively based on a call context associated with the call and the caller.

14. The system according to claim 13, wherein the speech recognition mechanism comprises:
a vocabulary adaptation mechanism for detecting the call context and for adaptively selecting the at least one vocabulary based on the detected call context;
an acoustic model adaptation mechanism for dynamically selecting the at least one acoustic model that are adaptive to the call context and the caller so that the performance of the speech recognition mechanism is optimized;
an automatic speech recognizer for performing speech recognition on the speech of the caller using the at least one vocabulary and the at least one acoustic model.

15. A vocabulary selection mechanism, comprising:
a call context detection mechanism for detecting a call context based on relevant information associated with a call from a caller; and
a vocabulary selection mechanism for selecting an appropriate vocabulary based on the call context.

16. The mechanism according to claim 15, wherein the call context detection mechanism detects the call context based on at least some of:
geographical information associated with the call;
customer information from a customer profile to which the caller is associated with; and
acoustic characteristics associated with the caller and detected from the speech of the caller.

17. An acoustic model adaptation mechanism, comprising:
an acoustic model selection mechanism for adaptively selecting at least one acoustic model based on a call context of a call placed by a caller; and
an adaptation mechanism for dynamically updating the acoustic model selection made by the acoustic model selection mechanism based on the performance of an automatic speech recognizer to generate an updated acoustic model.

18. The mechanism according to claim 17, wherein the adaptation mechanism updates a customer profile associated with the caller based on the updated acoustic model.

19. A machine-accessible medium encoded with data, the data, when accessed, causing:
receiving a call from a caller associated with a customer;
fowarding relevant call information associated with the call;
detecting a call context associated with the call based on the call information;
selecting at least one vocabulary according to the call context;
identifying at least one acoustic model for each of the at least one vocabulary based on the call context; and
recognizing speech content of the call using the at least one vocabulary and the at least one acoustic model.

20. The medium according to claim 19, wherein the at least one vocabulary includes at least some of:
a digits vocabulary in a particular language,
a letter vocabulary in a particular language,
a word vocabulary in a particular language, and
a generic vocabulary in a particular language; and
the at least one acoustic model representing a specific accent with respect to a particular vocabulary.

21. The medium according to claim 20, wherein the call context includes at least some of:
geographical information associated with the call which includes:
an area code representing a geographical area from where the call is placed,
an exchange number representing a geographical region from where the call is placed, or
a caller identification number representing a phone through which the call is placed by the caller;
customer information associated with the customer which includes:
an account number representing an account using which the customer places the call,
the caller identification number associated with the account; or
customer characteristics.

22. The medium acording to claim 21, wherein the customer characteristics associated with the customer include at least some:
gender of at least one caller associated with the customer;
zero or more languages for communication preferred by the at least one caller; or
speech accent with respect to the preferred languages of the at least one caller.

23. The medium according to claim 22, wherein said detecting a call context comprises at least some of:
extracting the geographical information of the call from the relevant call information associated with the call;
identifying the customer information from a customer profile corresponding to the account number using which the customer places the call; or
identifying the customer characteristics based on the speech of the customer.

24. The medium according to claim 19, the data, when accessed, further causing:
accessing the performance of said recognizing;
re-selecting at least some of the vocabulary and the acoustic models that correspond to better performance of said recognizing according to said assessing.

25. A machine-accessible medium encoded with data for selecting an appropriate vocabulary, the data, when accessed, causing:
receiving call information relevant to a call placed by a caller associated with a customer;
retrieving, if the call information provides appropriate identification, a customer profile, accessed using the appropriate identification, to obtain customer information;
detecting a call context associated with the call based on the call information and the customer information; and
selecting an appropriate vocabulary based on the call context.

26. The medium according to claim 25, wherein said detecting comprises:
extracting geographical or customer information from the call information;
obtaining customer information from the customer profile; or
detecting caller characteristics based on the speech of the caller.

27. A machine-accessible medium encoded with data for selecting an appropriate acoustic model, the data, when accessed, causing:
receiving a call context, relevant to a call placed by a caller associated with a customer, and a vocabulary; and
selecting at least one acoustic model with respect to the vocabulary based on the call context.

28. The medium according to claim 27, wherein said selecting includes at least some of:
analyzing relevant customer information contained in the call context; and
determining the speech characteristics of the caller from the speech of the caller.

29. A machine-accessible medium encoded with data for adaptively adjusting vocabulary and acoustic model selection, the data, when accessed, causing:
performing speech recognition using at least one vocabulary and associated at least one acoustic model, selected according to a call context related to a call from a caller, on the speech from the caller;
assessing the performance of the speech recognition with respect to each of the at least one vocabulary and each of its associated acoustic models; and
re-selecting an updated vocabulary or an updated acoustic model based on assessed speech recognition performance so that said performing speech recognition is to be carried out using the updated vocabulary and the updated acoustic model.

30. The medium system according to claim 29, the data, when accessed, further causing:
updating a customer profile, associated with the caller, based on the updated acoustic model.
